(19) United States
(12) Patent Application Publication
(10) Pub. No.: US 2008/0056792 A1
(43) Pub. Date: Mar. 6, 2008

(54) Post-processing apparatus bookbinding apparatus and image forming system

(75) Inventor: Hiroyasu Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MONOLTA BUSSINES TECHNOLOGIES, INC.

(21) Appl. No.: 11/730,626

(22) Filed: Apr. 3, 2007

(30) Foreign Application Priority Data
Aug. 30, 2006 (JP) JP2006-233327

(51) Int. Cl. G03G 15/00

(52) U.S. Cl. 399/408; 270/58.08

(57) ABSTRACT

A post-processing apparatus having a conveyance device to convey a sheet, a sheet bundle storing device to load and store the sheets conveyed by the conveyance device as a sheet bundle, a moving device to enable the sheet bundle storing device to be movable, a post-processing device to carry out post-process for the sheet bundle accumulated in the sheet bundle storing device, wherein the sheet bundle storing device can be withdrawn to outside the post-processing apparatus main body through the moving device so as to be capable of storing the sheet bundle from outside.

This application is based on Japanese Patent Application No. 2006-233327 filed on Aug. 30, 2006, in Japanese Patent Office, the entire content of which is hereby incorporated by reference.

### BACKGROUND OF THE INVENTION

The present invention relates to a post-processing apparatus and a bookbinding apparatus having a sheet bundle storing device to accumulate sheets and to store sheet bundles, and related to an image forming system having the aforesaid post-processing apparatus and the bookbinding apparatus.

For example, in an electrophotographic method image forming apparatus has a high-speed performance, a multifunction and a network function, and its application as a printing apparatus is being expanding by connecting with a large capacity sheet feeding apparatus and a large capacity stacker.

In case the image forming apparatus is used as a printing apparatus, one system can perform a job from printing to bookbinding in a single successive workflow by connecting the bookbinding apparatus to bind printed matters.

In a bookbinding apparatus of Patent document 1, sheets on which images are formed in an image forming apparatus are accumulated in a sheet accumulating apparatus having an oblique sheet accumulating surface and forms a sheet bundle which composes a book, and the sheet bundle is transferred to jointing process section, and thereafter the sheet bundle is turned to a vertical condition, then glue is applied and a front cover is jointed onto the sheet bundle in the vertical condition, so as to make a book.

Also, a bookbinding process wherein one sheet bundle accumulating printed sheets is covered by a front cover sheet (coversheet) in U-shape is known as a bookbinding process.

In Patent document 1, a compact size bookbinding apparatus is proposed to enable coupling up of the image forming apparatus and the printing apparatus.

Patent Document 1: Unexamined Japanese Patent Application Publication No. 2004-209869

In the bookbinding apparatus disclosed by Patent document 1, when bookbinding is manually executed by changing into offline system, the sheet bundle is loaded on a coversheet supplying device. The sheet loaded is fed to a sheet bundle storing device one by one and a sheet bundle is formed by a sheet bundle conveyance device, and then bookbinding process is carried out in a bookbinding processing section having a glue applying device, a coversheet adhesion device and coversheet folding device.

However, in case of cast work, for example, up to a maximum of 300 pieces of the sheets are bound. Thus it takes an enormous time, if the sheets are fed one by one.

### SUMMARY OF THE INVENTION

An aspect of the present invention is as follows.

1) A post-processing apparatus having: a conveyance device to convey a sheet; a sheet bundle storing device to load and store the sheet conveyed from the conveyance device as a sheet bundle; a moving device which enables the sheet bundle storing device possible to be withdrawn outside the post-processing apparatus; and a post-processing device to conduct post-processing for the sheet bundle accumulated in the sheet bundle storing device; wherein the sheet bundle can be stored from outside in the sheet bundle storing device being withdrawn outside the post-processing apparatus through the moving device.
2) A bookbinding apparatus having: a sheet bundle storing device to load and store the sheet as a sheet bundle; a sheet bundle conveyance device to grasp the sheet bundle stored in the sheet bundle storing device vertically by a grasping device; a square spine forming device to form a square spine by folding a coversheet after the coversheet is contacted and bonded with a pine of the sheet bundle grasped by the grasping device; and a moving device which enables the sheet bundle storing device to be withdrawn outside the post-processing apparatus; wherein the sheet bundle can be stored from outside in the sheet bundle storing device being withdrawn outside the post-processing apparatus through the moving device.
3) An image forming system, having: an image forming apparatus main body to form an image on a recording sheet based on manuscript data; and the bookbinding apparatus to bind a sheet bundle and comprise elements of item 2).

### BRIEF DESCRIPTION OF THE DRAWINGS

FIG. 1 is a total structural view of an image forming system having an image forming apparatus main body, a bookbinding apparatus and a booklet storing apparatus.

FIG. 2 is a cross-sectional view of the bookbinding apparatus related to the present invention.

FIG. 3 is a cross-sectional view of a status where a sheet accumulating device of a sheet bundle storing device is obliquely disposed.

FIG. 4 is a cross-sectional view of a status where the sheet accumulating device of the sheet bundle storing device is vertically disposed.

FIG. 5 is a cross-sectional view showing the sheet bundle storing device, an adhesive applying device, a coversheet supplying device, a coversheet cutting device and a square spine forming device.

FIG. 6 is a perspective view showing the adhesive applying device and a grasping device.

FIG. 7 (a)-FIG. 7 (d) are cross-sectional views of the square spine forming device and a sheet bundle explaining a process of folding a coversheet.

FIG. 8 (a)-FIG. 8(c) are perspective views indicating a forming process of booklet using the sheet bundle and the coversheet.

FIG. 9 is a cross-sectional view of the sheet bundle storing device.

FIG. 10 is a plane view of a bookbinding apparatus main body and the sheet bundle storing device.

FIG. 11 is a plane view of a status where the sheet bundle storing device is withdrawn from the bookbinding apparatus main body.

### DETAILED DESCRIPTION OF THE PREFERRED EMBODIMENT

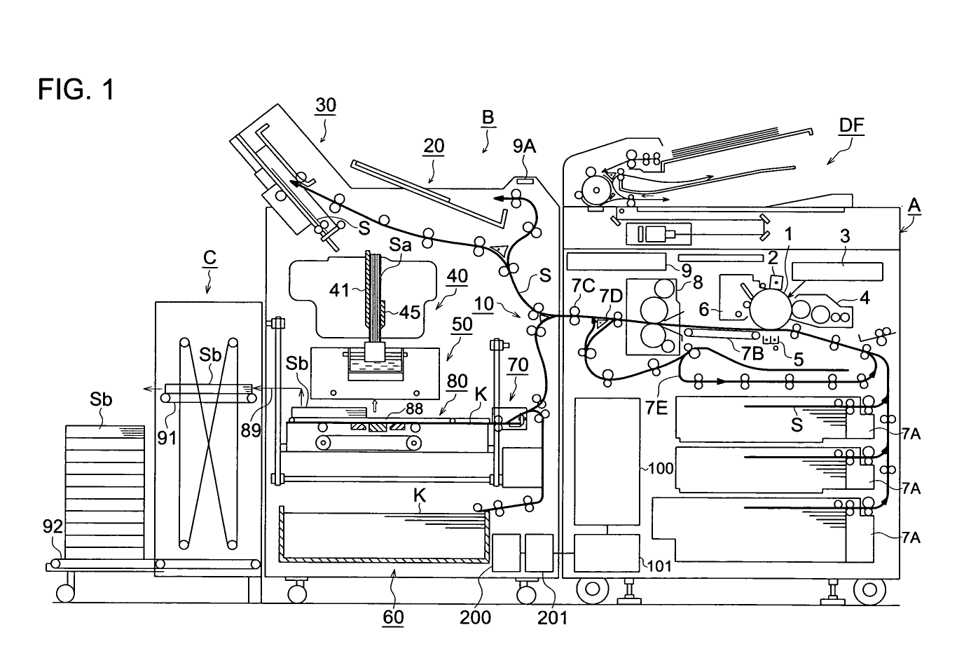

The bookbinding apparatus and image forming system having the bookbinding apparatus of the present invention are explained with reference to the drawings without the present invention being restricted thereto. FIG. 1 is a total configuration view of an image forming system having image forming apparatus main body A, bookbinding apparatus (post-processing apparatus) B, booklet storing apparatus C and automatic document feeding apparatus DF.

<Image Forming Apparatus Main Body A>

Image forming apparatus main body A is provided with an image forming device where charging device 2, image exposing device 3, developing device 4, transfer neutralization device 5 and cleaning device 6 are disposed in a peripheral of image carrier 1 which can rotate.

After charging device 2 carries out uniform charging on a surface of image carrier 1, the image forming device forms a latent image through exposure scanning based on image data read from a document through a laser beam of image exposing device 3, and developing device 4 develops the latent image through reversal development so as to form a toner image on a surface of image carrier 1.

A recording sheet S (hereinafter call sheet) fed from sheet storing device 7A, is sent to a transfer position. After the toner image is transferred onto sheet S through transfer neutralization device 5 in the transfer position, charge of sheet S is erased and sheet S is separated from image carrier 1. Then sheet S is conveyed through conveyance device 7B and successively fixed by heat through fixing device 8 and then ejected from sheet ejecting roller 7C.

In case the image is formed on both sides of sheet S, sheet S fixed by heat through fixing device 8 is branched from a normal sheet ejection pass by conveyance pass switching device 7D and is reversed upside down through switching back in reversal conveyance device 7E. After that, sheet S goes through image forming section again to form an image on a reverse side of sheet S, then through fixing device 8, sheets S is ejected by sheet ejecting roller 7C to outside the apparatus. Sheet S ejected from sheet ejection roller 7C is fed into bookbinding apparatus B.

The surface of image carrier 1 after image processing is cleaned by cleaning device 6 to remove remaining developer on the surface, thereby being ready for next image forming.

On an upper section of image forming apparatus main body A, operation device 9 provided with an input device and a display device is disposed.

<Bookbinding Apparatus B>

As FIG. 1 shows, bookbinding apparatus B related to the present invention is a case work bookbinding apparatus having sheet conveyance device 10, sheet ejection device 20, sheet reversal device 30, sheet bundle storing device 40, bonding adhesive applying device 50, coversheet supplying device 60, coversheet cutting device 70 and square spine forming device 80. Each of the devices is disposed serially in a substantially vertical direction inside bookbinding apparatus B.

Meanwhile, the post-processing apparatus of the present invention is applicable to a side stitching device, a saddle folding and stitching device and a cast sealing device, besides the case work bookbinding device.

Main control device 100 of image forming apparatus main body A and post-processing control device 200 of bookbinding device B are connected through serial communication devices 101 and 102.

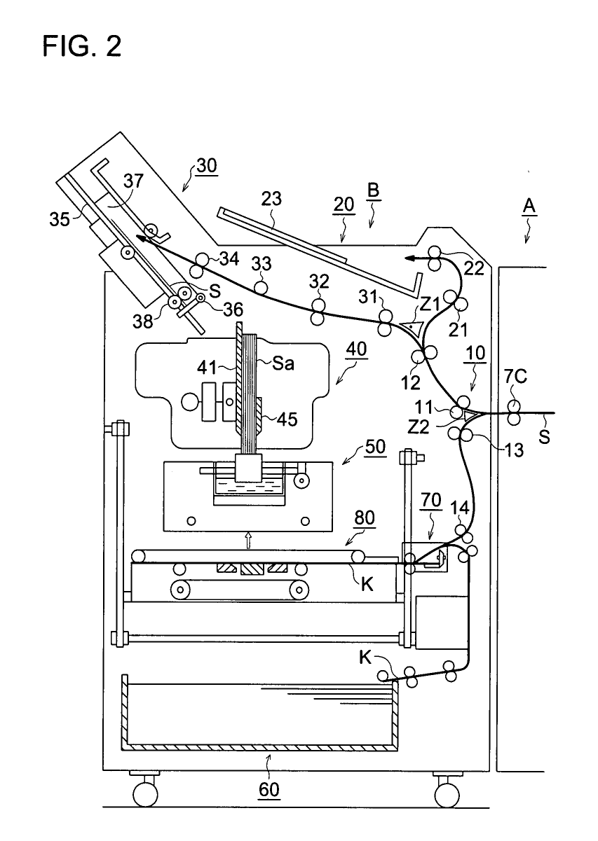

FIG. 2 is a cross-sectional view of bookbinding device B related to the present invention.

<Sheet Conveyance Device 10>

Sheet S introduced into sheet conveyance device 10 is grasped by conveyance rollers 11 and 12 to be conveyed and then branched either to sheet ejection device 20 or to sheet reversal device 30 through conveyance pass switching device Z1.

Conveyance pass switching device Z2 disposed at an upstream side of conveyance roller 11 in a sheet conveyance direction sends sheet S ejected from image forming apparatus main body A either to a conveyance pass of conveyance roller 11 or to a conveyance pass of conveyance roller 13. Sheet S conveyed to the conveyance pass of conveyance roller 13 is grasped by conveyance roller 14 to be conveyed to square spine forming device 80.

<Sheet Ejection Device 20>

If this conveyance pass to sheet ejection device 20 is selected, conveyance pass switching device Z1 shuts off a conveyance pass to sheet bundle storing device 40 and opens a conveyance pass to sheet ejection device 20.

Sheet S passing through the conveyance pass of sheet ejection device 20 is grasped by conveyance roller 21 to be conveyed upward, then sheet S is ejected by sheet ejection roller 22 and stored on fixed sheet ejection tray 23 on a top of the apparatus through ejection roller 22. Fixed sheet ejection tray 23 is able to directly receive sheet S ejected from image forming apparatus main body A and load approximately 200 pieces of sheets S on it.

<Sheet Reversal Device 30>

Sheet S divaricated by conveyance pass switching device Z1 leftward in the figure in a downstream side of a sheet conveyance direction is grasped by conveyance rollers 31, 32, 33 and 34 to be stored in a prescribed position in sheet reversal device 30. Sheet reversal device 30 has obliquely disposed sheet loading table 35, sheet end positioning member 36, which can swing, sheet width aligning member 37, conveyance roller 38 and rear end aligning member 39.

<Sheet Bundle Storing Device 40>

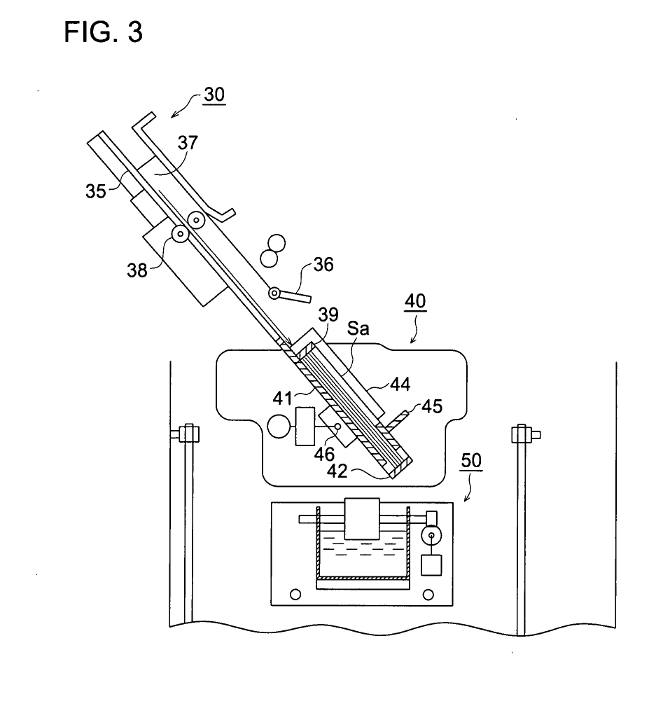

FIG. 3 is a cross-sectional view showing a status where the sheet accumulation device of sheet bundle storing device 40 is disposed obliquely.

The sheet accumulation device has supporting member 41, receiving plate 42, lateral aligning member 44 and imposing member 45.

Sheets S placed on sheet set on table 35 of sheet reversal device 30 is grasped by roller 38 and ejected from an opening opened by swing of sheet rear end positioning member 36 to be conveyed downward on an angle. Sheets S are stored and accumulated successively in sheet bundle storing device 40.

Sheet bundle storing device 40 has supporting member 41 having an oblique accumulation surface and receiving plate 42 which can swing. Sheet S which comes down from sheet reversal device 30 slips on the accumulating surface and falls down until a front edge section of sheet S comes in contact with receiving plate 42 and stops, thereby being supported in an oblique status.

Rear end aligning member 39, pushes the rear end section of sheet S so that the front end section of sheet S comes in contact with receiving plate 42 for aligning the front end section (longitudinal aligning) in accordance with the size of sheet S placed on the accumulation surface.

Sheets S successively ejected from image forming apparatus main body A are conveyed by switching back in sheet reversal device 30 and accumulated in sheet bundle storing device 40. Then longitudinal aligning and lateral aligning to be described are conducted to form sheet bundle Sa configured with a plurality of sheets S.

A size of sheet S and number of the sheets configuring sheet bundle Sa, are set through operation device 9 of image forming apparatus main body A shown in FIG. 1. Or they are set on an external devices such as personal computers connected with image forming apparatus main body A.

Lateral aligning member 44, pushes a side edge of sheet S conveyed from sheet reversal device 30 and stored in sheet bundle storing device 40 so as to align sheet s in a width direction (lateral alignment) while an online system in which a process from image forming to bookbinding is carried out automatically is in operation.

While an offline system in which bookbinding is conducted alone, a power supply to lateral aligning member 44 is stopped, and the width direction of the sheet bundle conveyed from outside to sheet bundle storing device 40 is aligned by operating lateral aligning member 44 manually.

Pressure member 45 grasps sheet bundle Sa accumulated in sheet bundle storing device 40 by pressing it in a thickness direction. At a stage where sheets S of a set quantity are stored in sheet bundle storing device 40, pressing member 45 is operated through an unillustrated driving device so as to grasp and hold sheet bundle Sa by the grasping device configured with supporting member 41 and pressing member 45.

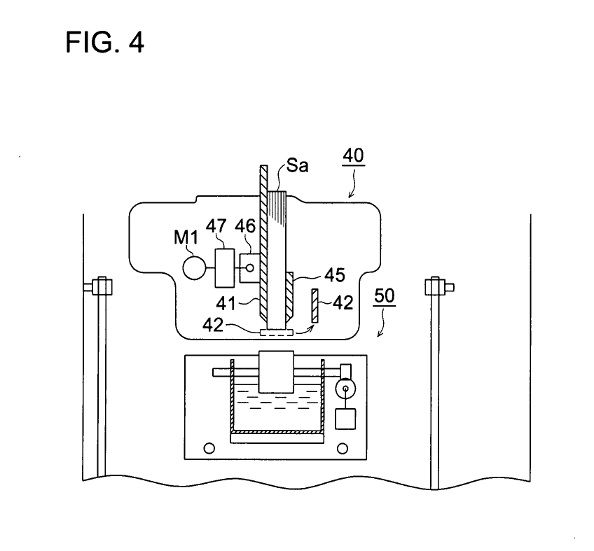

FIG. 4 is a cross-sectional view showing a status where the sheet accumulating device of sheet bundle storing device 40 is disposed vertically.

Supporting member 41 and pressing member 45 holding sheet bundle Sa are rotated centering on axis 46 of sheet bundle storing device 40 through an unillustrated motor and driving device 47 so that sheet bundle Sa becomes vertical status from oblique status. In this status, adhesive applying device 50 is retracted downward and a bottom surface of sheet bundle Sa is detached from adhesive applying roller 51 of adhesive applying device 50.

Also, in a status where supporting member 41 and pressing member 45 are holding sheet bundle Sa, receiving plate 42 is rotated and retracted from a broken lines position to a solid line position shown by the figure through an unillustrated driving device.

<Adhesive Applying Device 50>

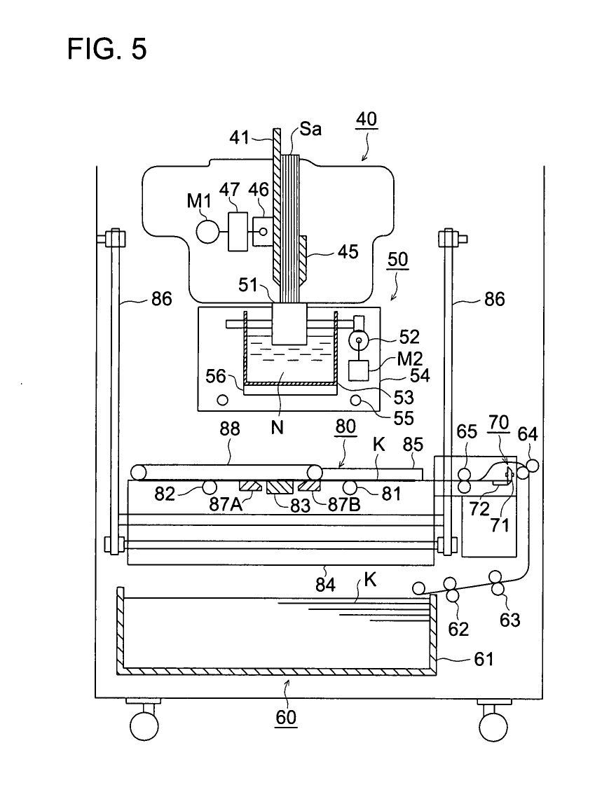

FIG. 5 is a cross-sectional view showing sheet bundle storing device 40, adhesive applying device 50, coversheet supplying device 60, coversheet cutting device 70 and square spine forming device 80.

Adhesive applying device 50 includes adhesive applying roller 51, driving device 52 to rotate the aforesaid adhesive applying device 50, adhesive container 53 to contain adhesive (glue) N, moving body 54 which supports adhesive container 53 and moves from a initial position at rear surface side R of bookbinding apparatus B to an adhesive applying position at front surface side F, adhesive container moving device 55 to reciprocate moving body 54, and heating device 56 to heat adhesive N contained in adhesive container 53.

<Applying Adhesive to Sheet Bundle>

Moving body 54 of adhesive applying device 50 is moved by an unillustrated driving device in a direction parallel to a longitudinal direction of a bottom surface of sheet bundle Sa which is held vertically by the grasping device configured with supporting member 41 and pressing member 45.

Moving body 54 starts to move from the initial position at rear surface side R of bookbinding apparatus B and moves along adhesive container moving device 55 then stops at a predetermined position at front surface side F of bookbinding apparatus B. After that moving body 54 is driven in reverse way to return to the initial position.

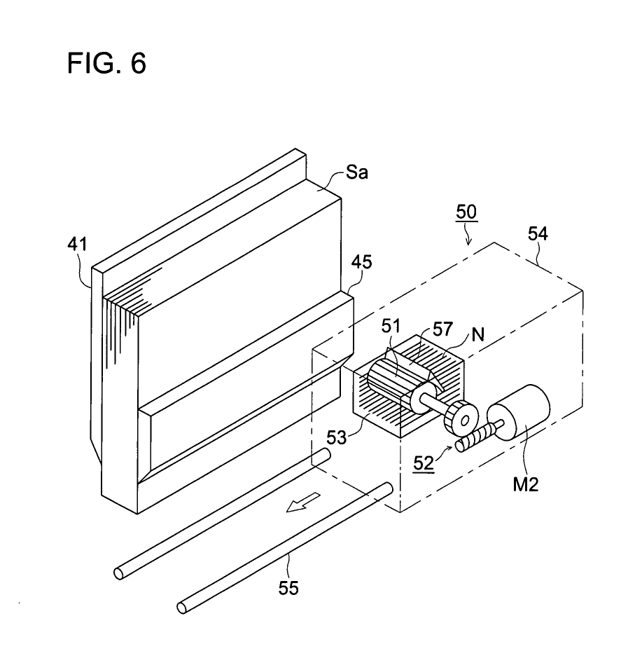

FIG. 6 is a perspective view showing adhesive applying device 50 and grasping device.

Adhesive applying roller 51 immersed in adhesive container 53 containing adhesive N is rotated by motor M2 and driving device 52. Adhesive applying roller 51 applies adhesive N on the bottom surface of sheet bundle Sa in its longitudinal direction in a stroke or in reciprocations of moving body 54.

Adhesive N applied on an outer circumferential surface of rotating adhesive applying roller 51 is controlled and uniformed in its layer thickness by adhesive layer control member 57.

<Coversheet Supplying Device 60>

As FIG. 5 shows, front coversheet (hereinafter called coversheet) K which is stored in coversheet loading device 61 of coversheet supplying device 60 is separated and fed by sheet supplying device 62, and then grasped by conveyance rollers 63, 64 and 65 to be conveyed to square spine forming device 80.

<Coversheet Cutting Device 70>

Coversheet cutting device 70, integrally constructed on the right of square spine forming device 80 to be described and above coversheet supplying device 60 in the figure, cuts a coversheet in a predetermined length in a conveyance direction of coversheet K by a rotary cutter configured with rotation blade 71 and fixed blade 72.

The predetermined length is a length which is two times of the length of sheet S in sheet conveyance direction and a length of the spine. For example, in case of case binding where coversheet K is bonded onto the spine of sheet bundle Sa which is configured with sheet S having A4 size, provided that a maximum number of sheets in sheet bundle Sa is 300 pieces and a maximum thickness is approximately 30 mm, the predetermined length is set at 450 mm which is two times of length of short side of A4 of 210 mm and the thickness of the sheet bundle of 30 mm, thereby an end section of coversheet K is cut. A wide size exceeding 450 mm is used as a length of coversheet K before cutting.

Also, in case booklet Sb is made through case binding using sheets S having each of A5 size, B5 size and 8.5×11 inch size (1 inch is 25.4 mm), the predetermined size is set based on the length of short side of the sheet and the thickness of the sheet bundle.

When the sheet size, the number of the sheets and the thickness of the sheet are selected or detected through operation device 9 of image forming apparatus main body A or through the external devices, a control device sets a predetermined cutting length of coversheet K. The length of coversheet K before cutting is determined in advance in accordance with an maximum number of sheets and stored in coversheet loading device 61 of coversheet supplying device 60.

<Square Spine Forming Device 80>

Square spine forming device 80 has conveyance rollers 81 and 82 to receive, convey and stop at a predetermined position coversheet K supplied from coversheet supplying device 60, supporting member 83 to press coversheet K onto an adhesive applying surface of sheet bundle Sa, moving housing 84 to support conveyance rollers 81 and 82, and supporting member 83, and elevating device 86 to vertically ascend and descend aligning device 85 and moving housing 84.

Spine forming device 80 and booklet ejection belt 88 are ascended and descended integrally by elevating device 86.

When square spine forming device 80 stops at descending position so as to bring in coversheet K, aligning device 85 moves from the initial position in accordance with the size of coversheet K and presses both side surfaces of coversheet K in the width direction before cutting process so as to align the width. Coversheet K of which skew is corrected through width aligning is switched back in a reverse direction of a direction of bringing in and conveyed to coversheet cutting device 70 to be cut in a predetermined position.

Also, before square spine forming device 80 joints coversheet K after cutting with the spine of sheet bundle Sa in the descending position, aligning device 85 is again moves from the initial position and presses both side surfaces of coversheet K in the width direction to carry out width aligning, then places coversheet K in a predetermined position. After that aligning device 85 returns to the initial position without bothering the jointing of coversheet K and sheet bundle Sa, then subsequently square spine forming device 80 ascends. Coversheet K is supported in a predetermined position while ascending.

Therefore, aligning device 85 disposed on square spine forming device 80, which can ascend and descend, carries out positioning in the width direction of coversheet K before and after cutting by coversheet cutting device 70, thereby improvement of coversheet cutting accuracy and positioning accuracy of sheet bundle Sa against coversheet K, as well as simplification of the structure can be achieved.

Elevating device 86 rotate left and right belts so as to move moving housing 84 upward. At this ascending position, a center section of coversheet K loaded on supporting member 83 is pressed and bonded onto the adhesive applying surface of sheet bundle Sa. Adhesive applying device 50 is retracted backward after adhesive applying process to sheet bundle Sa is completed.

<Coversheet Folding Process>

At upper section of square spine forming device 80, a coversheet folding device is disposed. The coversheet folding device has a pair of symmetrical forming members 87A and 87B. Forming members 87A and 87B can attach and detach to/from sheet bundle Sa in a direction of a thickness of sheet bundle Sa. Forming members 78A and 87B fold coversheet K along a side edge of the adhesive applying surface of sheet bundle Sa and a front coversheet and a rear coversheet lap front and rear surfaces of sheet bundle Sa.

After folding process of coversheet K is completed, square spine forming device 80 descents a predetermined amount by descending drive of elevating device 86 to be retracted and to stop. Thereafter, when grasping by the grasping device is released, booklet Sb falls and a lower surface of the spine comes in contact with upper surface of ejection belt 88 and the booklet Sb is loaded on the surface thereof to be ejected.

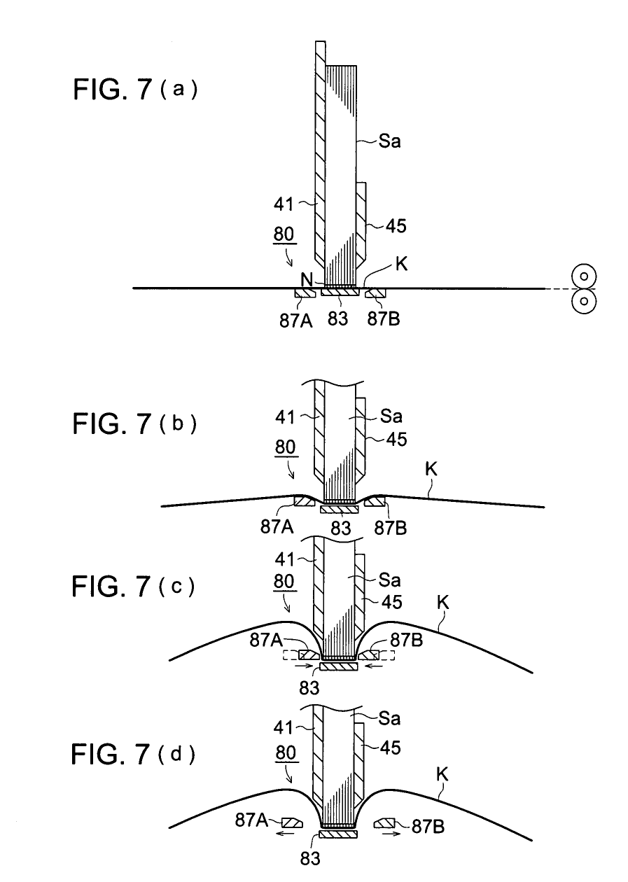

FIG. 7(a) to FIG. 7(d) are a cross-sectional views of square spine forming device 80 and sheet bundle Sa showing a folding process of coversheet K. FIG. 7 (a) shows a status where coversheet folding is started, FIG. 7(B) shows a status of a middle of coversheet folding, FIG. 7 (c) is a status where coversheet folding is completed and FIG. 7 (d) shows a status where a pressure of coversheet folding is released.

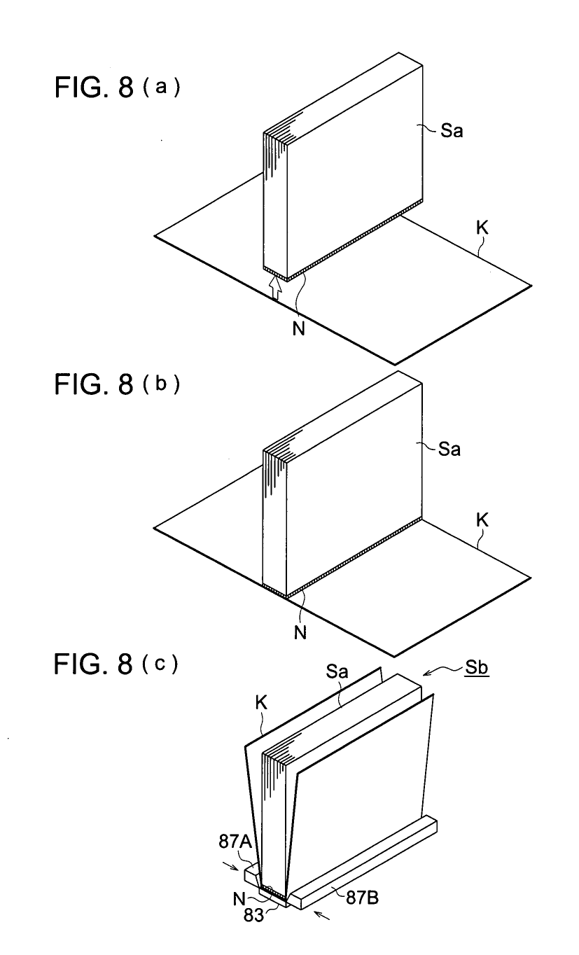

FIG. 8(a) to FIG. 8(b) are perspective views showing a forming process of booklet Sb using sheet bundle Sa and coversheet K. FIG. 8 (a) is a perspective view showing coversheet K and sheet bundle Sa in a status before bonding process, FIG. 8 (b) a perspective view of sheet bundle Sa where coversheet K is bonded, and FIG. 8 (c) is a perspective view of booklet Sb to be formed where coversheet K is case bound on sheet bundle Sa.

After coversheet K and sheet bundle Sa on which adhesive N is applied are bonded, forming members 87A and 87B are driven by an unillustrated driving device in an ascent status of square spine forming device 80 shown in FIG. 8. Coversheet K is grasped by forming members 87A and 87B and deformed from the side edge section of adhesive applying surface (Refer to FIG. 7 (b)).

Thereafter, forming members 87A and 87B move horizontally towards the adhesive applying surface side of sheet bundle Sa so as to press both side surfaces of sheet bundle Sa for shaping, thereby booklet Sb is formed.

As FIG. 1 shows, pressing member 45 opens to release grasping, then booklet Sb falls and is loaded on the upper surface of ejection belt 88 to be conveyed in a direction of booklet ejecting outlet 89 and ejected to booklet storing device C outside the apparatus.

Ejected booklet sb is loaded on conveyance belt 91, which can ascend and descend, of booklet storing device C and is ejected successively by rotation of conveyance belt 91, thereby loaded and stored on ejected sheet table 92.

<Installation of Sheet Bundle into Sheet Bundle Storing Device>

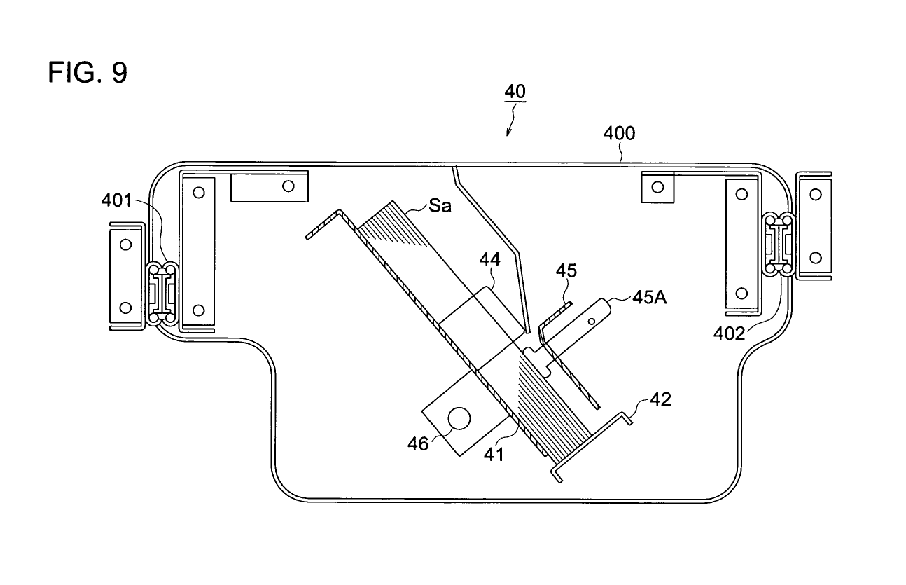

FIG. 9 is a cross-sectional view of sheet bundle storing device 40.

Housing 400 of sheet bundle storing device 40 is supported by slide bearings 401 and 402 representing the moving device to be able to withdraw from the bookbinding apparatus main body.

When sheet S ejected form sheet reversal device 30 is stored in sheet bundle storing device 40 or when sheet bundle storing device 40 is in an initial status, as FIG. 3 and FIG. 9 show, the sheet bundle supporting device configured with supporting member 41, receiving plate 42, lateral aligning member 44 and pressing member 45 and 45A is obliquely supported.

In present the embodiment, since sheet bundle Sa set in sheet bundle storing device 40 is loaded on a surface of supporting member 41 and grasped by pressing device 45 and 45A at the same position, sheet bundle Sa does not have to be conveyed from sheet bundle storing device 40 to a position of grasping. Therefore shortening of a process time of bookbinding where bookbinding apparatus B is operated by its own becomes possible.

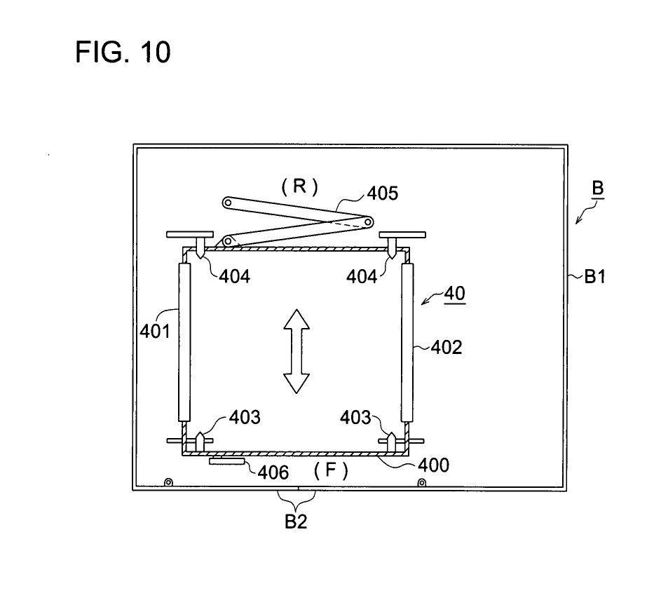

FIG. 10 is a plane view showing bookbinding apparatus main body B1 and sheet bundle storing device 40.

Housing 400 of sheet bundle storing device 40 is slidably supported in an outlined arrow direction shown in the figure by bookbinding apparatus main body B1 through slide bearings 401 and 402.

Two projecting members 403 implanted on front surface side F of housing 400 engage with holes made in predetermined positions on bookbinding apparatus main body B1 so as to position front surface side F of hosing 400. Also two projecting members 404 implanted in predetermined positions on bookbinding apparatus main body B1 engage with holes made on rear surface side R of hosing 400 so as to position rear surface side R of housing 400.

On rear surface side R of housing 400, folding device 405 where two arms are linked in V-shape is disposed. An end section of one arm is supported by bookbinding apparatus main body B1 and an end section of the other arm is supported by rear surface side R of housing 400.

Grip 406 disposed on front surface side F of housing 400 is used when housing 400 is moved manually. Also, it operates a locking mechanism to lock housing 400 while being retracted as well as to unlock housing 400 when stating moving.

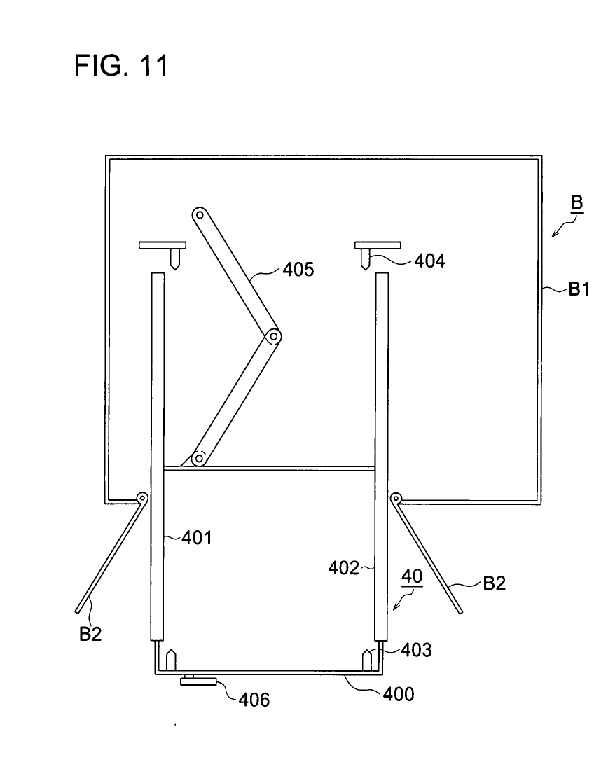

FIG. 11 is a plane view showing a status where sheet bundle storing device 40 is being withdrawn from bookbinding apparatus main body B1.

When sheet bundle Sa of printed matters, which are printed outside, is stored in sheet bundle storing device 40, offline systems, on which only bookbinding apparatus B is operated alone, is selected and front door B2 of bookbinding apparatus main body B1 is opened so as to release the lock by operating grip 406 of sheet bundle storing device 40, thereafter sheet bundle storing device 40 is withdrawn forward by holding grip 406.

The upper part of withdrawn sheet bundle storing device 40 is opened and the sheet bundle supporting device configured with supporting member 41, receiving plate 42, lateral alignment member 44, and pressing member 45 and 45A is exposed.

An operator grasps sheet bundle Sa and places it on the surface of supporting member 41 in an oblique condition shown in FIG. 9 then contacts the front end section of sheet bundle Sa to receiving plate 42 so as to align the front end section. Meanwhile, at this stage, pressing members 45 and 45a are retracted backward by a distance more than a maximum thickness of the sheet bundle.

Next, lateral aligning of sheet bundle Sa is conducted by operating lateral aligning member 44 manually. Sheet bundle storing device 40 storing sheet bundle Sa which is positioned through front end section aligning and lateral aligning is pushed back into bookbinding apparatus main body by operating grip 406 manually. Then housing 400 is aligned by projecting members 403 and 404.

Thereafter, when bookbinding start button 9A disposed on an upper section of bookbinding apparatus B is pressed (refer to FIG. 1), sheet bundle supporting device configured with supporting member 41, receiving plate 42, lateral aligning member 44, and pressing members 45 and 45A stands vertically, then the aforesaid processes such as applying adhesive, coversheet bonding, forming spine and ejecting booklet are carried out. In present embodiment, the grasping device grasps sheet bundle Sa in the same position where sheet bundle is set in sheet bundle storing device 40. Thereby, sheet bundle Sa does not have to be moved from sheet bundle storing device 40 to a grasping position by the grasping device. Thus, in case bookbinding is carried out by operating bookbinding apparatus B by itself, a time period of bookbinding processing can be shortened.

According aforesaid the embodiment the following can be realized:

1. In the post-processing apparatus related to the present embodiment the moving device is provided, which enables the sheet bundle storing device to load the sheets and store them as a sheet bundle withdrawn outside the apparatus main body. Thereby the sheet bundle can be stored in the sheet bundle storing device at once with a simple operation, as the result, post-processing such as binding process and adhesive applying process can be carried out rapidly.

2. In the bookbinding apparatus related to the present embodiment, in case the bookbinding apparatus is manually used, the sheet bundle storing device is withdrawn outside the apparatus main body, thus the sheet bundle can be set from outside in the sheet bundle storing device, thereby adhesive applying bookbinding process can be completed in a short time.

3. In the image forming system related to the present embodiment, by the image forming apparatus connected with the bookbinding apparatus, online system where a job from image forming to bookbinding is carried out automatically and offline system where bookbinding is conducted by itself can be switched over appropriately to carry image forming process and bookbinding process, thereby efficiency of bookbinding is improved.

What is claimed is:

1. A post-processing apparatus comprising:
a conveyance device to convey a sheet;
a sheet bundle storing device to load and store sheets conveyed by the conveyance device as a sheet bundle;
a moving device which enables the sheet bundle storing device to be withdrawn outside the post-processing apparatus; and
a post-processing device to conduct post-processing for the sheet bundle accumulated in the sheet bundle storing device;
wherein a sheet bundle can be stored from outside in the sheet bundle storing device being withdrawn outside the post-processing apparatus through the moving device.

2. A bookbinding apparatus comprising:
a sheet bundle storing device to load and store sheets as a sheet bundle;
a sheet bundle conveyance device to grasp the sheet bundle stored in the sheet bundle storing device vertically by a grasping device;
a square spine forming device to form a square spine by folding a coversheet after the coversheet is contacted and bonded with a pine of the sheet bundle grasped by the grasping device; and
a moving device which enables the sheet bundle storing device to be withdrawn outside a bookbinding apparatus main body;
wherein a sheet bundle can be stored from outside in the sheet bundle storing device being withdrawn outside the post-processing apparatus through the moving device.

3. A bookbinding apparatus of claim 2, wherein the grasping device can be withdrawn outside the bookbinding apparatus along with the sheet bundle storing device.

4. A bookbinding apparatus of claim 2, wherein the sheet bundle storing device has a lateral aligning device to align the sheet stored in the sheet bundle storing device in a width direction of the sheet.

5. A bookbinding apparatus of claim 4, wherein the lateral aligning device manually aligns the sheet bundle stored in the sheet bundle storing device in the width direction when the sheet bundle is stored from outside into the sheet bundle storing device being withdrawn outside the bookbinding apparatus.

6. A bookbinding apparatus of claim 2, wherein the sheet bundle storing device comprises a front end positioning member to position the sheet bundle stored by contacting with a front end section of the sheet bundle.

7. A bookbinding apparatus of claim 2, wherein the bookbinding apparatus is a case work bookbinding apparatus to perform case binding by bonding the coversheet and the spine of the sheet bundle so as to form the square spine.

8. An image forming system, comprising:
an image forming apparatus main body to form an image on a sheet based on manuscript data; and
the bookbinding apparatus to bind a sheet bundle and comprise elements of claim 2.
